(19) United States
(12) Patent Application Publication
(10) Pub. No.: US 2009/0189858 A1
(43) Pub. Date: Jul. 30, 2009

(54) Gesture Identification Using A Structured Light Pattern

(76) Inventors: Jeff Lev, Tomball, TX (US); Earl Moore, Cypress, TX (US); Jeff Parker, Magnolia, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/242,092

(22) Filed: Sep. 30, 2008

Related U.S. Application Data
(60) Provisional application No. 61/024,838, filed on Jan. 30, 2008.

(51) Int. Cl. G06F 3/033; H04N 5/228

(52) U.S. Cl. 345/158; 348/222.1; 348/E05.031

(57) ABSTRACT

In at least some embodiments, a computer system includes a processor. The computer system also includes a light source. The light source provides a structured light pattern. The computer system also includes a camera coupled to the processor. The camera captures images of the structured light pattern. The processor receives images of the structured light pattern from the camera and identifies a user gesture based on distortions to the structured light pattern.

### CROSS REFERENCE TO RELATED APPLICATIONS

This application claims the benefit of provisional patent application Ser. No. 61/024,838, filed Jan. 30, 2008, titled “Gesture Identification Using A Structured Light Pattern.”

### BACKGROUND

Most computer system input devices are two-dimensional (2D). As an example, a mouse, a touchpad, or a point stick can provide a 2D interface for a computer system. For some applications, special buttons or keystrokes have been used to provide a three-dimensional (3D) input (e.g., a zoom control button). Also, the location of a radio frequency (RF) device with respect to a receiving element has been used to provide 3D input to a computer system. Improving 2D and 3D user interfaces for computer systems is desirable.

### BRIEF DESCRIPTION OF THE DRAWINGS

For a detailed description of exemplary embodiments of the invention, reference will now be made to the accompanying drawings in which:

FIG. 1 shows a user interacting with a computer system in accordance with embodiments of the invention;

FIG. 2 shows a side view of an object interacting with the computer system of FIG. 1 in accordance with embodiments of the invention;

FIG. 3A illustrates a structured light pattern being generated in accordance with embodiments of the invention;

FIG. 3B illustrates a structured light pattern being distorted by an object in accordance with embodiments of the invention;

FIG. 4 shows a block diagram of an illustrative computer architecture in accordance with embodiments of the invention;

FIG. 5 shows a simplified block diagram of a computer system in accordance with embodiments of the invention; and

FIG. 6 illustrates a method in accordance with embodiments of the invention.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Embodiments of the invention provide a two-dimensional (2D) or three-dimensional (3D) input to a computer system based on monitoring distortions to a “structured light pattern.” As used herein, a structured light pattern refers to a predetermined pattern or grid of lines and/or shapes. Although not required, some of the lines and/or shapes may intersect. When a 3D object is placed into the structured light pattern, the reflection of the structured light pattern on the 3D object is distorted based on the shape/curves of the 3D object. In at least some embodiments, a camera captures reflections of the structured light pattern from objects moving into the area where the structured light pattern is projected. In some embodiments, the light source, the camera, and the digital signal processing are tuned to maximize the signal-to-noise ratio of reflections from the structured light pattern versus ambient light. For example, the light source may be a laser diode that creates a strong signal in a narrow band of frequencies. In some embodiments, the camera has a filter that passes the frequency of the laser diode and rejects other frequencies (a narrow band-pass filter). In this manner, the structured light pattern and distortions thereof are easily identified.

In at least some embodiments, the distortions to the structured light pattern are identified as user gestures (e.g., hand gestures). These gestures can be correlated with a function of the computer system. As an example, the movement of a user's hand within the structured light pattern could control an operating system (OS) cursor and button clicking operations (similar to the function of a mouse or touchpad). Also, gestures could be used to move, to open or to close folders, files, and/or applications. Within drawing or modeling applications, hand gestures could be used to write (e.g., pen strokes or sign language) or to move/rotate 2D objects and/or 3D objects. Within gaming applications, hand gestures could be used to interact with objects and/or characters on the screen. In general, various hand gestures such as pointing, grabbing, turning, chopping, waving, or other gestures can each be correlated to a given function for an application or OS.

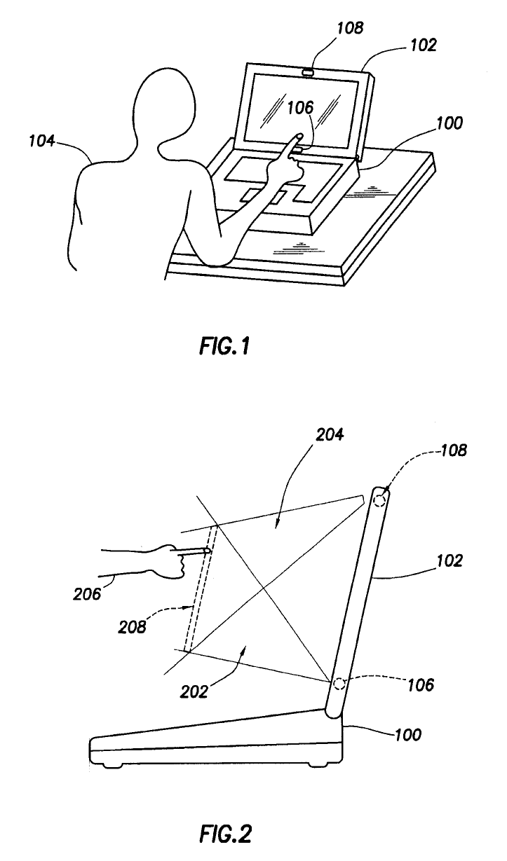

FIG. 1 shows a user 104 interacting with a computer system 100 in accordance with embodiments of the invention. The computer system 100 is representative of a laptop computer although other embodiments (e.g., a desktop computer or handheld device) are possible. The computer system 100 has a light source 106 and a camera 108 that enable identification of gestures as will later be described. As an example, the user 104 can interact with the computer system 100 based on movement of a hand or a hand-held object.

FIG. 2 shows a side view of an object 206 interacting with the computer system 100 of FIG. 1 in accordance with embodiments of the invention. As shown, a structured light pattern 202 is emitted by the light source 106. In at least some embodiments, the structured light pattern 202 is not visible to the user 102 (e.g., infrared light). When the object 206 (e.g., a user's hand) is placed into the field of the structured light pattern 202, distortion to the structured light pattern 202 occurs. The camera 108 is positioned such that the camera view 204 intersects the structured light pattern 202 to create a detection window 208. Within the detection window 208, the object 206 distorts the structured light pattern 202 and the camera 108 captures such distortion.

Although FIG. 2 shows the light source 106 at the bottom of the display 102 and the camera 108 at the top of the display 102, other embodiments are possible. As an example, the light source 106 and/or the camera 108 may be located at the top of the display 102, the bottom of the display 102, the main body of the computer system 100, or separate from the computer system 100. If separate from the computer system 100, the light source 106 and/or the camera 108 may be attached to the computer system 100 as peripheral devices via an appropriate port (e.g., a Universal Serial Bus or “USB” port).

In various embodiments, the camera 108 is capable of capturing images in the visible light spectrum, the infrared light spectrum or both. For example, the digital light sensor (not shown) of the camera 108 may be sensitive to both visible light and infrared light. In such case, the camera 108 may filter visible light in order to better capture infrared light images. Alternatively, the camera 108 may filter infrared light to better capture visible light images. Alternatively, the camera 108 may simultaneously capture visible light images and infrared light images by directing the different light spectrums to different sensors or other techniques. Alternatively, the camera 108 may selectively capture infrared light images and visible light images (switching back and forth as needed) by appropriately filtering or re-directing the other light spectrum.

In summary, many types of cameras and image capture schemes could be implemented, which vary with respect to lens, light spectrum filtering, light spectrum re-directing, digital light sensor function, image processing or other features. Regardless of the type of camera and image capture scheme, embodiments should be able to capture reflected images of the structured light pattern 202 and any distortions thereof. In some embodiments, visible light images could be captured by the camera 108 for various applications (e.g., a typical web-cam). Even if the camera 108 is only used for capturing images of the structured light pattern 202, the computer system 100 could include a separate camera (e.g., a web-cam) to capture visible light images.

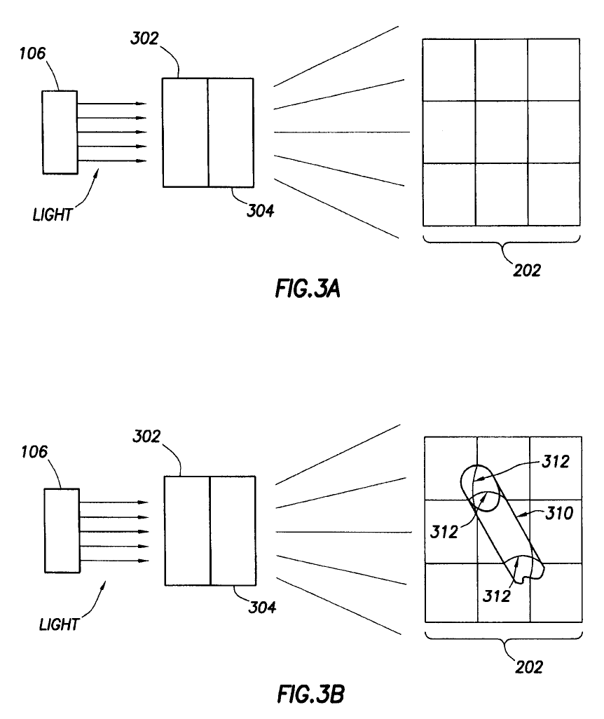

FIG. 3A illustrates a structured light pattern 202 being generated in accordance with embodiments of the invention. As shown in FIG. 3A, the light source 106 generates light, which is input to a lens 302 and a grid 304. The light may be visible or non-visible to a user 104 (non-visible light such as infrared is preferable). The lens 302 disperses the light and the grid 304 causes the light to be output in a particular pattern referred to as the structured light pattern 202. In general, the structured light pattern 202 may comprise any predetermined pattern of lines and/or shapes. Although not required, some of the lines and/or shapes may intersect. As an example, FIG. 3A shows a structured light pattern 202 having intersecting straight lines. The light source 106, the lens 302 and the grid 304 and any other components used to create the structured light pattern 202 can be understood to be a single unit referred to herein as a “light source.”

FIG. 3B illustrates a structured light pattern 202 being distorted by an object 310 in accordance with embodiments of the invention. As shown, if the object 310 is placed into the structured light pattern 202, distortions 312 in the structured light pattern 202 occur. The distortions 312 vary depending on the object 310 and the orientation of the object 310. Thus, the distortions 312 can be used to identify the object 310 and the position/orientation of the object 310 as will later be described. Further, if the camera 108 captures multiple frames in succession (e.g., 30 frames/second), any changes to the position/orientation of the object 310 can be used to identify gestures. For more information regarding structured light patterns and object detection, reference may be had to C. Guan, L. G. Hassebrook, and D. L. Lau, “Composite structured light pattern for three-dimensional video,” Optics Express, Vol. 11, No. 5, pp. 406-417 (March 2003), which is herein incorporated by reference. Also, reference may be had to J. Park, C. Kim, J. Yi, and M. Turk, “Efficient Depth Edge Detection Using Structured Light,” Lecture Notes in Computer Science, Volume 3804/2005 (2005), which is hereby incorporated by reference.

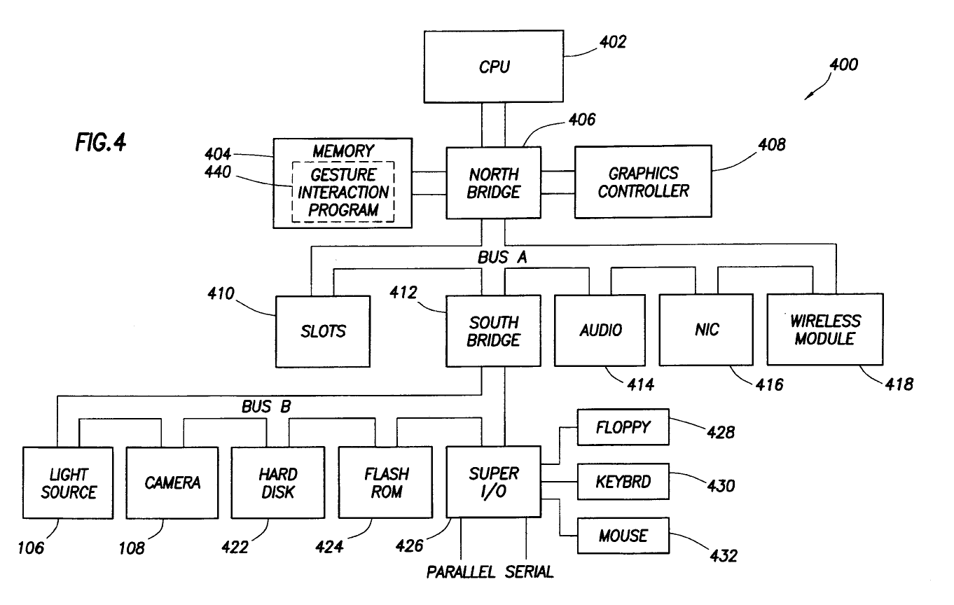

FIG. 4 shows a block diagram of an illustrative computer architecture 400 in accordance with embodiments. This diagram may be fairly representative of the computer system 102, but a simpler architecture would be expected for a handheld device. The computer architecture 400 comprises a processor (CPU) 402 coupled to a bridge logic device 406 via a CPU bus. The bridge logic device 406 is sometimes referred to as a “North bridge” for no other reason than it is often depicted at the upper end of a computer system drawing. The North bridge 406 also couples to a main memory array 404 (e.g., a Random Access Memory or RAM) via a memory bus, and may further couple to a graphics controller 408 via an accelerated graphics port (AGP) bus. The North bridge 406 couples the CPU 402, the memory 404, and the graphics controller 408 to the other peripheral devices in the system through a primary expansion bus (BUS A) such as a PCI bus or an EISA bus. Various components that comply with the bus protocol of BUS A may reside on this bus, such as an audio device 414, a network interface card (NIC) 416, and a wireless communications module 418. These components may be integrated onto a motherboard or they may be plugged into expansion slots 410 that are connected to BUS A. As technology evolves and higher-performance systems are increasingly sought, there is a greater tendency to integrate many of the devices into the motherboard which were previously separate plug-in components.

If other secondary expansion buses are provided in the computer, as is typically the case, another bridge logic device 412 is used to couple the primary expansion bus (BUS A) to the secondary expansion bus (BUS B). This bridge logic 412 is sometimes referred to as a “South bridge” reflecting its location relative to the North bridge 406 in a typical computer system drawing. Various components that comply with the bus protocol of BUS B may reside on this bus, such as a hard disk controller 422, a Flash ROM 424, and a Super I/O controller 426. The Super I/O controller 426 typically interfaces to basic input/output devices such as a keyboard 630, a mouse 632, a floppy disk drive 628, a parallel port and a serial port.

A computer-readable medium makes a gesture interaction program 440 available for execution by the processor 402. In the example of FIG. 4, the computer-readable medium corresponds to RAM 404, but in other embodiments, the computer-readable medium could be other forms of volatile, as well as non-volatile storage such as floppy disks, optical disks, portable hard disks, and non-volatile integrated circuit memory. In some embodiments, the gesture interaction program 440 could be downloaded via wired computer networks or wireless links and stored in the computer-readable medium for execution by the processor 402.

The gesture interaction program 440 configures the processor 402 to receive data from the camera 108, which captures frames of the structured light pattern 202 and the distortions 312 as described previously. The captured frames are compared with stored templates to identify objects/gestures within the structured light pattern 202. Each object/gesture can be associated with one or more predetermined functions depending on the application. In other words, a given gesture can perform the same function or different functions for different applications.

In at least some embodiments, the gesture interaction program 440 also directs the CPU 402 to control the light source 106 coupled to the CPU 402. In alternative embodiments, the light source 106 need not be coupled to nor controlled by the CPU 402. In such case, a user could manually control when the light source 106 is turned on and off. Alternatively, a detection circuit could turn the light source on/off in response to the computer system turning on/off or some other event (e.g., detection by motion sensors or other sensors) without involving the CPU 402. In general, the light source 106 needs to be turned on when the gesture interaction program 440 is being executed or at least when the camera 108 is capturing images. In summary, control of the light source 106 could be manual or could be automated by the CPU 402 or a separate detection circuit. The light source 106 could be included as part of the computer architecture 400 as shown or could be a separate device.

There are many ways in which the gesture interaction program could be used. As an example, the movement of a user's hand within the structured light pattern could control an operating system (OS) cursor and button clicking operations (similar to the function of a mouse or touchpad). Also, gestures could be used to move, to open or to close folders, files, and/or applications. Within drawing or modeling applications, hand gestures could be used to write or to move/rotate 2D objects and/or 3D objects. Within gaming applications, hand gestures could be used to interact with objects and/or characters on the screen. In general, various hand gestures such as pointing, grabbing, turning, chopping, waving, or other gestures can each be correlated to a given function for an application or OS. Combinations of gestures can likewise be used. In at least some embodiments, a hand-held object rather than simply a hand can be used for make a gesture. Thus, each gesture may involve identification of a particular object (e.g., a hand and/or a hand-held object) and the object's position, orientation and/or motion.

FIG. 5 shows a simplified block diagram of a computer system 500 in accordance with embodiments of the invention. In FIG. 5, a processor 402 couples to a memory 404. The memory 404 stores the gesture interaction program 440, which may comprise a user interface 442, gesture recognition instructions 444, gesture templates 446 and a gesture/function database 448. The memory 404 may also store applications 460 having programmable functions 462. As shown, the processor 402 also couples to a graphic user interface (GUI) 510, which comprises a liquid crystal display (LCD) or other suitable display.

When executed by the processor 402, the user interface 442 performs several functions. In at least some embodiments, the user interface 442 displays a window (not shown) on the GUI 510. The window enables a user to view options related to the gesture interaction program 440. For example, in at least some embodiments, the user is able to view and re-program a set of default gestures and their associated functions 462 via the user interface 442. Also, the user may practice gestures and receive feedback from the user interface 442 regarding the location of the detection window 208 and how to ensure proper identification of gestures.

In at least some embodiments, the user interface 442 enables a user to record new gestures and to assign the new gestures to available programmable functions 462. In such case, the light source 106 emits a structured light pattern and the camera 108 captures images of the structured light pattern while the user performs a gesture. Once images of the gesture are captured, a corresponding gesture template is created. The user is then able to assign the new gesture to an available programmable function 462.

When executed, the gesture recognition instructions 444 cause the processor 402 to compare captured images of the structured light pattern 202 to gesture templates 446. In some embodiments, each gesture template 446 comprises a series of structured light pattern images. Additionally or alternatively, each gesture template 446 comprises a series of 3D images. Additionally or alternatively, each gesture template 446 comprises a series of vectors extracted from structured light patterns and/or 3D images. Thus, comparison of the captured structured light pattern images to gesture templates 446 may involve comparing structured light patterns, 3D images, and/or or vectors. In some embodiments, the gesture recognition instructions 444 also cause the processor 402 to consider a timing element for gesture recognition. For example, if the camera 108 operates at 30 frames/second, the gesture recognition instructions 444 may direct the processor 402 to identify a given gesture only if completed within a predetermined time period (e.g., 2 seconds or 60 frames).

If a gesture is not recognized, the user interface 442 may provide feedback to a user in the form of text (“gesture not recognized”), instructions (“slower,” “faster,” “move hand to center of detection window”) and/or visual aids (showing the location of the detection window 208 or providing a gesture example on the GUI 510). With practice and feedback, a user should be able to learn default gestures and/or create new gestures for the gesture interaction program 440.

If a gesture is recognized, the gesture recognition instructions 444 cause the processor 402 to access the gesture/function database 448 to identify the function associated with the recognized gesture. The processor 402 then performs the function. The gesture/function database 448 can be updated by re-assigning gestures to available functions and/or by creating new gestures and new functions (e.g., via the user interface 442).

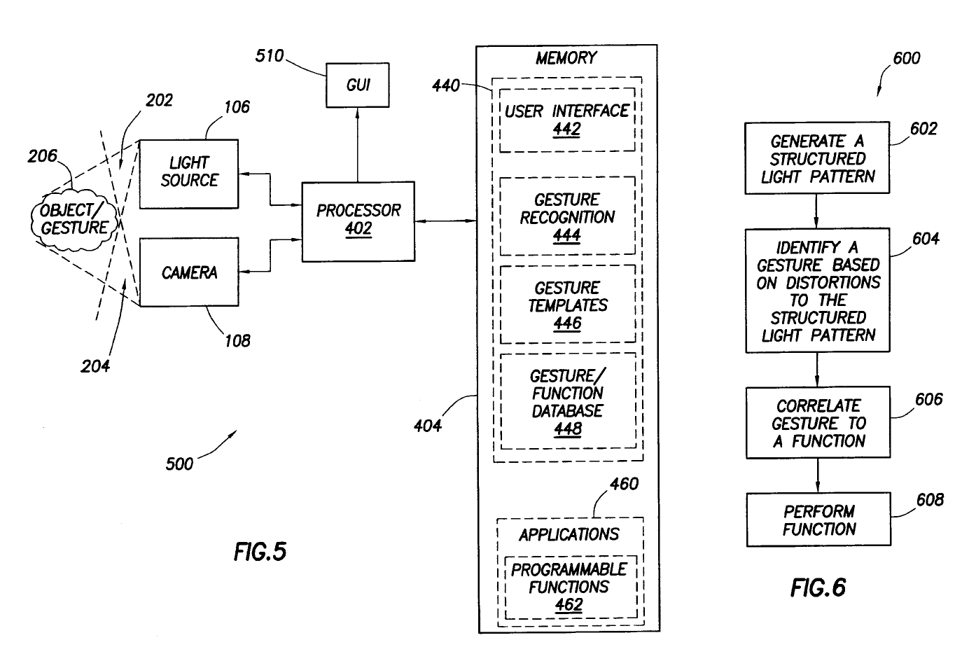

FIG. 6 illustrates a method 600 in accordance with embodiments of the invention. The method 600 comprises generating a structured light pattern (block 602). At block 604, a gesture is identified based on distortions to the structured light pattern. At block 606, the gesture is correlated to a function. Finally, the function is performed (block 608).

In various embodiments, the method 600 also comprises additional steps such as comparing distortions of the structured light pattern with one of a plurality of gesture templates to identify the gesture. In some embodiments, the method 600 also comprises capturing infrared light images of the structured light pattern to detect the distortions to the structured light pattern. Also, the method 600 may involve capturing visible light images of an object within the structured light pattern and displaying the captured visible light images to a user. Also, the method 600 may involve controlling a camera to selectively capture infrared light images of the structured light pattern and visible light images of an object within the structured light pattern. The method 600 also may include creating a gesture template and associating the gesture template with the function. In some embodiments, identifying the gesture comprises identifying an object (e.g., a hand or a hand-held object) within the structured light pattern, an object's position within the structured light pattern, an object's orientation within the structured light pattern and/or an object's motion within the structured light pattern. The method 600 may also include enabling a gesture to perform different functions depending on application.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A computer system, comprising:
a processor;
a light source, the light source provides a structured light pattern; and
a camera coupled to the processor, the camera captures images of the structured light pattern,
wherein the processor receives images of the structured light pattern from the camera and identifies a user gesture based on distortions to the structured light pattern.

2. The computer system of claim 1 further comprising a memory that stores a gesture interaction program for execution by the processor, wherein the gesture interaction program correlates the user gesture with a function of the computer system.

3. The computer system of claim 1 wherein the light source is selected from the group consisting of a manually-controlled light source, a processor-controlled light source and a detection circuit controlled light source.

4. The computer system of claim 1 wherein the gesture comprises at least one item selected from the group consisting of an object, an object's position, an object's orientation and an object's motion.

5. The computer system of claim 1 wherein the camera records infrared light images of the structured light pattern.

6. The computer system of claim 1 wherein the camera selectively records infrared light images of the structured light pattern and visible light images of an object within the structured light pattern.

7. The computer system of claim 6 wherein at least some of the visible light images are displayed to a user via a graphic user interface (GUI) to enable the user to interact with the gesture interaction program.

8. The computer system of claim 1 wherein the gesture interaction program enables the same gesture to perform different functions depending on application.

9. The computer system of claim 1 wherein the computer system is a laptop computer.

10. A method for a computer system, comprising:
generating a structured light pattern;
identifying a gesture based on changes to the structured light pattern;
correlating the gesture with a function of the computer system; and
performing the function.

11. The method of claim 10 further comprising comparing changes to the structured light pattern with one of a plurality of gesture templates to identify the gesture.

12. The method of claim 10 further comprising capturing infrared light images of the structured light pattern to detect the changes to the structured light pattern.

13. The method of 10 further comprising capturing visible light images of an object within the structured light pattern and displaying the captured visible light images to a user.

14. The method of claim 10 further comprising controlling a camera to selectively capture infrared light images of the structured light pattern and visible light images of an object within the structured light pattern.

15. The method of claim 10 further comprising creating a gesture template and associating the gesture template with the function.

16. The method of claim 10 wherein identifying the gesture comprises identifying at least one item selected from the group consisting of an object within the structured light pattern, an object's position within the structured light pattern, an object's orientation within the structured light pattern and an object's motion within the structured light pattern.

17. The method of claim 10 further comprising enabling the gesture to perform different functions depending on application.

18. A computer-readable medium comprising software that causes a processor of a computer system to:
identify a gesture based on changes to a structured light pattern;
correlate the gesture with a function of the computer system; and
perform the function.

19. The computer-readable medium of claim 18 wherein the software further causes the processor to identify the gesture by identifying at least one item selected from the group consisting of an object within the structured light pattern, an object's position within the structured light pattern, an object's orientation within the structured light pattern and an object's motion within the structured light pattern.

20. The computer-readable medium of claim 18 wherein the software further causes the processor to correlate the gesture with a different function depending on application.

21. The computer-readable medium of claim 18 wherein the software further causes the processor to create a gesture template based on input from a user and to associate the gesture template with the function.
